(19) United States
(12) Patent Application Publication
(10) Pub. No.: US 2025/0044183 A1
(43) Pub. Date: Feb. 6, 2025

(54) STRAIN MONITORING OF SUBMERGED STRUCTURES

(71) Applicant: AQUATEC GROUP LIMITED, Basingstoke (GB)

(72) Inventor: Andrew Michael SMERDON, Basingstoke (GB)

(21) Appl. No.: 18/786,487

(22) Filed: Jul. 27, 2024

(30) Foreign Application Priority Data
Jul. 31, 2023 (GB) 2311761.7

(51) Int. Cl. G01M 5/00

(52) U.S. Cl. CPC G01M 5/0041; G01M 5/0025

(57) ABSTRACT

A strain monitor which comprises a strain gauge assembly which comprises a carrier, which is arranged to engage with a surface of the submerged structure, and the carrier comprises multiple engagement formations which engage with said surface; a strain gauge, the strain gauge incorporated with the carrier; and a temperature sensor, which is incorporated with the carrier, and arranged to sense a temperature of said surface.

### TECHNICAL FIELD

The present invention relates to strain monitors for attachment to submerged structures, and uses thereof.

### BACKGROUND

For submerged structures, such as those used in the oil and gas and marine renewables industries, it can be important to monitor the structural stability/integrity thereof. This is known to be performed using a strain monitor, which is attached to the structure and used to determine prevailing strain measurements. Where the structure is a submerged support structure (such as for an offshore platform), the data gathered can be used for example to aid in the calibration of models that will inform decisions regarding de-manning of the platform in the event of extreme weather.

We have devised an improved strain monitoring assembly, which is suitable for monitoring a submerged structure.

### SUMMARY

The present invention includes several aspects, all related to novel strain monitors, and the uses thereof.

According to a first aspect of the invention, there is provided a strain monitor which comprises a strain gauge assembly which comprises:
a carrier, which is arranged to engage with a surface of the submerged structure, and the carrier comprises multiple engagement formations which engage with said surface;
a strain gauge, the strain gauge incorporated with the carrier;
a temperature probe, which is incorporated with the carrier, and arranged to sense a temperature of said surface.

By ‘submerged structure’ we include, for example, one or more of the following: subsea pipelines, risers, manifolds, conduits and flowlines, and more generally fluid containment structures which may be open or closed ended; underwater cables and cable protection systems, including cable bend restrictors, cable bend stiffeners, and cable flotation; underwater mooring chains, cables, and anchor points; offshore wind monopiles, floating structures and subsea wellheads.

The part of the submerged structure to which the strain monitor is to be attached may be a tubular member, and/or may have a curved or rounded outer surface.

The carrier may be termed a transfer mechanism.

The strain gauge may comprise a strain measuring element which may be subject to elongation or contraction in relation to strain experienced by the submerged structure.

The strain monitor may be configured to provide (structural) integrity monitoring to a submerged structure.

The carrier may be arranged to bear against the part of the submerged structure. The carrier may comprise multiple engagement/contact formations which are arranged to bear against the submerged structure. The engagement formations may be pointed, that is having a distal end which is smaller than an opposite distal end.

The carrier may be provided with multiple strain gauges, each with at least one strain measuring element. The strain gauge(s) may be configured in an electrical resistance determining circuit, which may be a Wheatstone bridge circuit.

The measurement of strain and temperature may be said to be at substantially one and same region of the surface of the structure, which may be termed a common measurement locality. It will be appreciated that the temperature may be measured at a singular point, which is part of or adjacent to a (larger) portion of the surface at which strain is measured.

The temperature probe may be incorporated with, into or on one or more of the engagement formations.

Multiple temperature probes may be provided.

In one embodiment of the invention, by combining measurement of strain (or put differently, measurement of linear deformation of a strain measuring element) at a substantially/effectively single location/locality on an underwater/submerged structure with a temperature measurement at substantially the same place, the combined effects of thermal expansion and stress-induced strain on submerged structures can be decoupled.

The strain monitor may comprise a data collection module. The data collection is arranged to receive, and store and/or process measurement outputs from the strain monitor.

The data collection module may be detachably connectable to the strain monitor.

A coupling or connector may be provided which is arranged to allow the data collection module to be mechanically and/or electrically connectable to measurement/data outputs from the strain monitor.

The data collection module may be arranged to effect at least one of the following functions: data processing, signal processing, data storage, data communication (externally of the data module), and power management.

The data collection module may comprise an emitter or a transceiver (and so allow, for example, stored and/or processed measurement data to be uploaded remotely of the installed strain monitor). To this end, the data collection module may comprise a communications port arranged to effect data or signalling to be output by the module and/or received as an input to the module. The communications port may be of a wired or wireless type. Wireless communication capability may include acoustic domain and/or optical domain communication types. Electromagnetic or radio frequency domain may additionally or alternatively be used. The transmission of collected and/or processed data may be to top-side, a location above water.

The data collection module may be configured to be installed underwater in proximity to the strain monitor. The data collection module and the strain monitor may collectively be referred to as a strain monitor assembly or system.

A second aspect of the invention is a system which comprises the strain monitor of the first aspect of the invention, and a data processor, wherein the data processor configured to determine a measure of strain induced stress, by use of a strain measurement and a temperature measurement which are taken at a common measurement locality of the surface.

The data processor may be arranged to determine the stress-induced strain by use of the relationship, or an equivalent thereto:

$$Δ L / L = α Δ T + σ / E$$

Where: ΔL/L is the proportionate change in length of the material under test, ΔT is the change in temperature, σ is stress, E is Young's Modulus, and σ/E is stress-induced strain (ε).

The measurement of strain may comprise the use of a strain gauge which employs the measurement of variable electrical resistance of a strain measuring element to determine strain (which is directly related to a proportional change in length of the gauge).

A third aspect of the invention is a method of determining stress induced strain in a submerged structure using a strain monitor applied to the submerged structure, the method comprising:
measuring strain;
measuring temperature at or proximal to where strain is measured, and the temperature and strain are measured at a common measurement region of the submerged structure;
using a strain measurement and the temperature measurement to deduce a stress induced strain value.

The stress induced strain value may be a value which is exclusive of any thermal expansion.

A fourth aspect of the invention is a method of determining a fluid pressure to which a submerged fluid containing structure is subjected, the method comprising:
obtaining strain measurements from a strain monitor which is secured to an inner or outer surface of a wall of the structure;
a pressure value to which the structure is subjected by use of a thickness of the wall of the structure and by use of the wall's Young's Modulus,
using the strain measurement along with the wall thickness and the Young's Modulus to determine said pressure value.

With knowledge of the thickness of the pressure vessel wall and its Young's Modulus, a change in pressure can be calculated from a change in measured strain.

Young's Modulus can be considered as a property of the material indicative of how easily it can stretch and deform. Young's Modulus may be defined as the ratio of tensile or compressive stress to tensile or compressive strain, or alternatively as the ratio of uniaxial stress to strain.

The method may comprise a determination of hoop stress.

For example, for a thin-walled cylindrical pressure-containing pipe (or other conduit), the hoop stress (σθ) is given by σθ=PDm/2t where P is pressure, Dm is mean diameter of the pipe, and t is wall thickness. The measured strain is the ratio of hoop stress to Young's Modulus (σθ/E). The method may comprise use of this relationship in determining an internal fluid pressure value.

The internal fluid pressure (or changes thereof) may be determined making use of either a measure of strain which does not take account of thermal expansion considerations or, alternatively, which does take account of thermal expansion (which may be in the manner set out about in the second aspect of the invention). The monitor of the first aspect may be used for the method, and the temperature information provided by the temperature sensor may or may not be used (by a data acquisition system) in generating a strain output.

In a fifth aspect of the invention there is provided a system which comprises a strain monitor and a data processor, and the data processor configured to process signals output by the monitor, and to use any required known values, such as thickness of the structure's wall and its Young's Modulus and a diameter of the structure, in order to use the same and so realise the process of the fourth aspect to determine a measure of pressure of fluid to which the structure is subjected.

According to a sixth aspect of the invention there is provided a system which comprises a strain monitor, a data processor, and a material thickness sensor which is capable of determining a wall thickness of a structure being monitored, and the data processor configured to process strain signals output by the monitor, as well as signals output by the thickness sensor so as to use an input comprising those signals to determine a measure of pressure of fluid inside the structure to which the structure is subjected.

According to a seventh aspect of the invention, there is provided strain measuring apparatus which comprises a number of strain monitors which are installed around a submerged structure, and the apparatus comprising a data processor configured to use measured strain data to determine a bending moment.

The monitors may be installed on a transverse plane of the structure. By transverse we include perpendicular to a length dimension of the structure. The monitors may be angularly distributed around a circumference of the structure. The monitors may be equally angularly spaced.

The strain monitors may be positioned such that at least some of them are oppositely positioned, for example in the case of four strain monitors, there are two pairs which are each diametrically opposed.

The apparatus may comprise four strain monitors.

The apparatus may comprise three strain monitors.

One or more of the strain monitors may be of the type of the first aspect of the invention.

The strain on each opposing surface can be deduced by the relationship Mb/(ZE), where Mb is the bending moment, Z is the Sectional Modulus, a geometric property of the cross-section under bending, and E is Young's Modulus. By measuring on opposing surfaces, the associated opposing strains associated with bending moment can be decoupled from axial strains that will be in the same direction. The data processor may be configured to implement processing of this relationship, or substantially so, in order for bending moment to be deduced from the measured strain data.

There may be a method of determining bending moment, using the apparatus of the sixth aspect of the invention.

According to an eighth aspect of the invention there is provided strain measuring apparatus which comprises two strain monitors, secured to an outer surface of submerged structure, and the strain monitors arranged at substantially 45 degrees relative to a torsional axis, and a data processor arranged to receive the strain data and thereby determine torsion to which the structure is subjected.

In a further aspect there is provided a strain monitor which is provided with one or more accelerometers which measure movement of the submerged structure that is monitored by the strain monitor when in use measuring strain of the structure.

Any of the above aspects of the invention may comprise, either singularly in combination, one or more features disclosed above, in the description and/or shown in the drawings. This disclosure includes that any features disclosed in the description and/or drawings can be used to supplement any of the above aspects, and for such purpose none of those features, individually, is inextricably linked to any other such feature, notwithstanding that multiple features may be disclosed in the context of a particular embodiment in relation to other features. The aspects above may be combined in any permutation, including that a strain monitor used in relation to any of the fourth to eighth aspects may of the type defined by the first aspect in making use of temperature readings for use in calculating strain or in deducing a parameter value which includes the use of temperature measurement. The present disclosure also includes that any of the fourth to eighth aspects may include use of a strain monitor a strain monitor which comprises a strain gauge assembly which comprises a carrier, which is arranged to engage with a surface of the submerged structure, and the carrier comprises multiple engagement formations which engage with said surface, and a strain gauge, the strain gauge incorporated with the carrier.

### BRIEF DESCRIPTION OF THE DRAWINGS

Various embodiments of the invention are now disclosed, by way of example only, in which:

FIG. 1 is a perspective view of a strain monitor,

FIG. 2 is a circuit diagram of a Wheatstone bridge which is connected to strain measuring elements of the strain monitor of FIG. 1,

FIG. 3 is a schematic of two views, perspective and side elevation, of the strain monitor of FIG. 1 installed on a submerged structure,

FIG. 4 is a schematic of two views, perspective and transverse section, of the strain monitor of FIG. 1 installed on a submerged structure used to measure internal fluid pressure,

FIG. 5 is a modified embodiment of FIG. 4 shown as schematic cross-section, in which a thickness sensor is mounted to a submerged structure.

FIG. 6 is a schematic of two views of multiple strain monitors, one a perspective view and the other a longitudinal cross-section, of the type of FIG. 1, situated around a circumference of a submerged structure, and are configured to output signals which can be used to deduce bending moment,

FIG. 7 shows two schematic views, one perspective and the other a transverse cross-section, of a submerged structure onto which are mounted two strain monitors, and

FIG. 8 shows two schematic views showing a further embodiment.

### DETAILED DESCRIPTION

There are now described various embodiments of a novel strain monitor which incorporates a temperature sensor, and example use applications thereof. There are also described novel methods and systems in relation to a submerged structure which use a strain monitor.

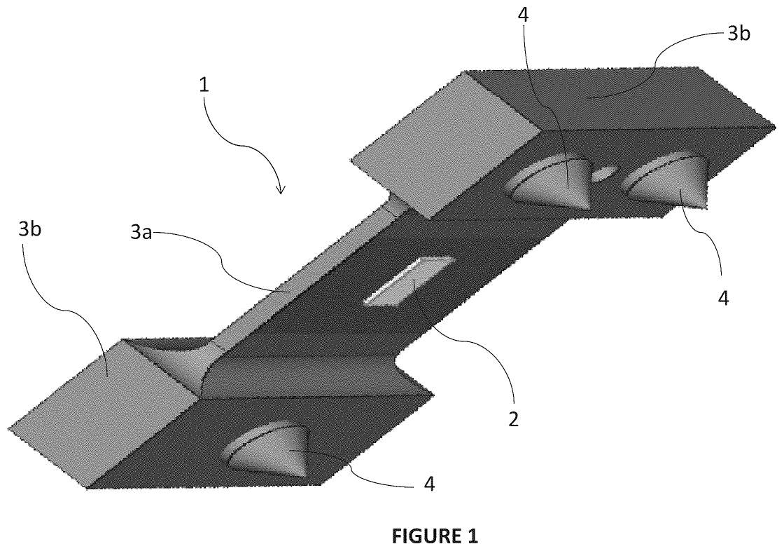

FIG. 1 shows a strain monitor device 1, which is arranged to be secured to a surface of a submerged structure. The device 1 comprises a strain gauge carrier (which may be thought of as the main body of the monitor). The carrier comprises a central web 3a, which is provided at each end thereof with a respective distal end portion 3b. Two strain gauges 2 are installed to the carrier and in particular are installed at the dimensionally central point of the web 3a on opposite sides thereof (that is on an upper side and a lower side). Fitting two gauges isolates the longitudinal axis strain and helps exclude any bending effects from the output measurement.

One of the distal end portions 3b comprises a single contact portion 4, which may be described as a pointed stud, of substantially conical shape. The other distal end portion 3b of the carrier comprises two such contact portions 4 in a spaced-apart relationship. The three contact portions 4 are arranged in a triangular configuration. The shape of the contact portions allows the same to engage with the surface and so be maintained in a substantially fixed/immovable position relative the surface. A suitable attachment assembly (not shown) is used to force the three contact portions 4 to bear against the surface of the submerged structure with a sufficient force. The contact formations 4 may be made of a suitably hard material.

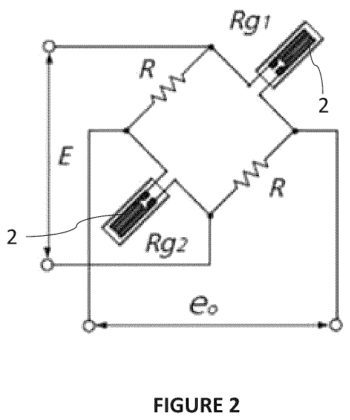

The pair of strain gauges 2 is connected in a half Wheatstone bridge circuit configuration, as shown in FIG. 2. The strain gauges 2 are of the electrical resistance measuring type in which a change in measured resistance corresponds to a change in strain.

One of the contact portions 4 incorporates a temperature sensor which engages with the surface of the submerged structure to measure the temperature thereof. For (advantageous) reasons that will become apparent from the examples below, the strain and temperature are measured at a common measurement locality.

The drawings which are described below include one or more strain monitoring devices of the type shown in FIG. 1.

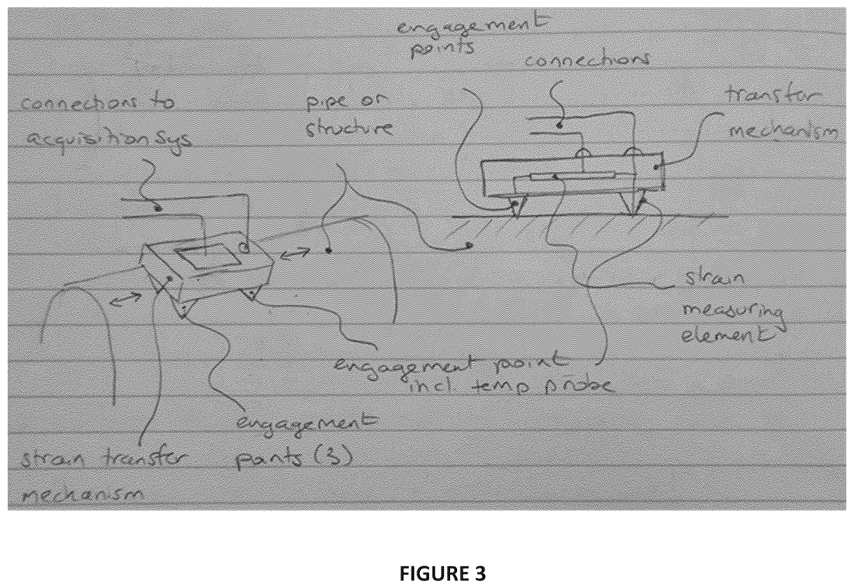

FIG. 3 shows two schematic views of a strain monitor device secured to a submerged structure, such as a pipe, namely a perspective view and a side view. It can be seen that the device is connected to a data acquisition system which captures and processes the resistance and temperature data from the installed device. It is shown in the Figure that the temperature sensor is a probe which is incorporated into one of the contact formations (4) such that a tip of the formation brings the probe into contact with the surface of the structure.

With knowledge of the coefficient of thermal expansion (a) of the material of the structure, data captured from the device allows separation of changes in thermal expansion/contraction from changes in stress-induced strain. The proportionate change in length of the structure material test (ΔL/L) sensed by the strain transfer mechanism is the sum of the thermal expansion and the stress-induced strain: ΔL/L=αΔT+σ/E, where ΔT is the change in temperature, σ is stress, E is Young's Modulus, and σ/E is stress induced strain (ε).

By using the above-described device to measure strain at a single location on the circumference of an underwater fluid containing structure or vessel under pressure, changes in the internal pressure in the vessel can be calculated without the need for dedicated internal or external sensing equipment (for specifically measuring internal pressure).

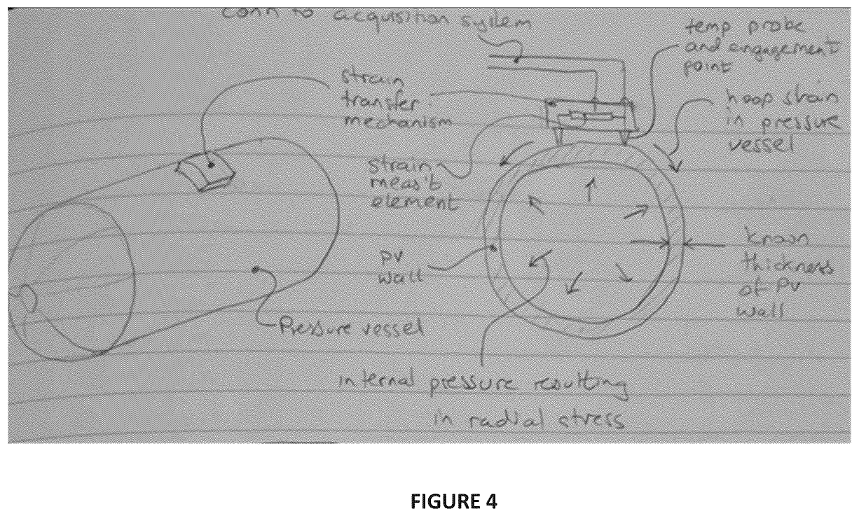

Reference is made to FIG. 4 which is schematic including two views of the strain monitoring device secured to a fluid containing structure, such as a vessel. A first view is a perspective view and a second view is a transverse cross-section. An increase in pressure within a cylindrical pressure vessel, such as a pipe, generates (radial) stress around the circumference of the pipe wall, which is termed hoop stress. This will in turn generate a change in the strain around the circumference of the pipe wall, which the device 1 can measure, and which can then be used. As is shown in FIG. 4, connectivity, such as by cables, from the strain monitor device to a data acquisition system, is provided.

With knowledge of the thickness of the vessel wall and of its Young's Modulus, a change in pressure within the vessel can be calculated from a change in measured strain. For example, for a thin-walled cylindrical pressure containing pipe, the hoop stress (σθ) is given by σθ=PDm/2t where P is pressure, Dm is mean diameter, and t is wall thickness. The measured strain is the ratio of hoop stress Young's Modulus (σθ/E). It will be appreciated that measured strain, for use in determining pressure, need not take account of temperature measures at the measurement locality (even though the device 1 may be capable of measuring the same). In fact, in a variant of the device 1, no temperature probe is provided, and it is a device which measures strain by way of measuring changes in electrical resistance due to elongation or contraction of the strain measuring element.

However, the temperature probe of the device 1 may be used in order to take into account the effects of temperature changes on the vessel so they can be compensated for, and so enable measurements of internal fluid pressure changes in the case of a pressure vessel which us also subject to temperature changes.

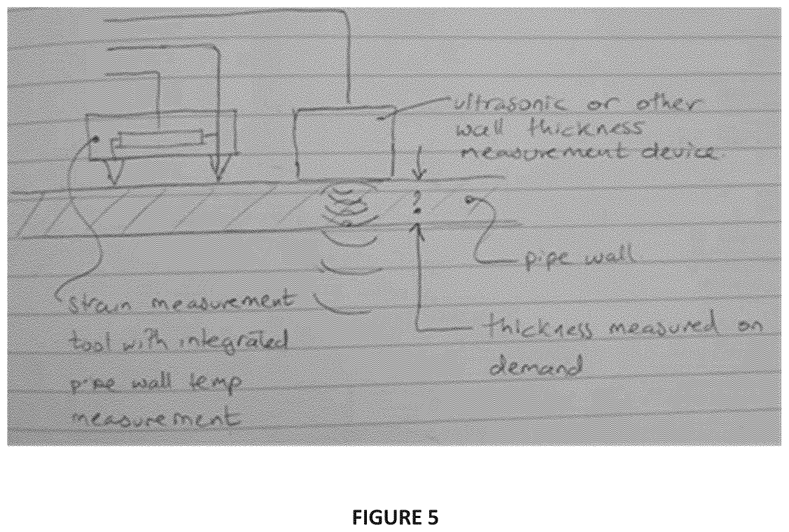

FIG. 5 shows an embodiment which is a modification of that shown in FIG. 4. In the drawing, a schematic longitudinal cross-section is shown of a fluid containing submerged structure. In this embodiment, a thickness sensor, for example an ultrasonic thickness sensor, is added such that the pressure vessel wall thickness t can be measured. As compared to the embodiment of FIG. 4, the internal pressure can be calculated without prior knowledge of the wall thickness. A signal from the thickness sensor is fed into a data acquisition system, which can then use the same in combination with sensed strain, and optionally with temperature measurements.

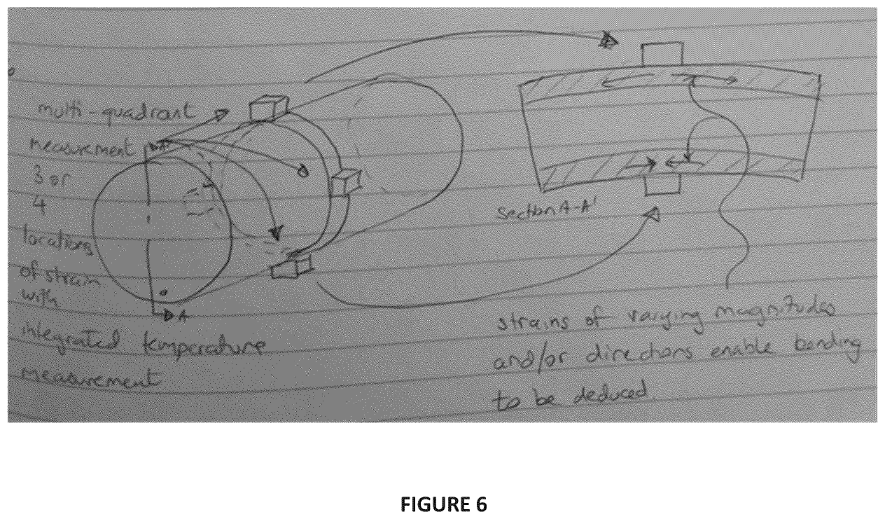

FIG. 6 shows a further implementation of strain monitors, which may be of the type described above. In this implementation multiple strain monitors are located around a submerged structure, such as an underwater pipe. The monitors are positioned around a circumference of the outer surface of the pipe, at angularly equal points. The monitors are substantially aligned to a plane which is transverse of the longitudinal extent of the pipe. More specifically, the strain monitors are located on two opposing faces perpendicular to a bending moment, such that the bending moment may be calculated. This may be termed multi-quadrant measurement. Each of the strain monitors is spaced apart by ninety degrees to its neighbour. This arrangement enables strains of different magnitudes and directions to be detected, which then allows bending moment to be determined.

The strain on each opposing surface is given by Mb/(ZE), where Mb is the bending moment, Z is the Sectional Modulus, a geometric property of the cross-section under bending, and E is Young's Modulus. By measuring on opposing surfaces, the associated opposing strains associated with bending moment can be decoupled from axial strains that will be in the same direction.

Although the embodiment in FIG. 6 shows the use of four strain monitors, three strain monitors could be used in a variant embodiment, which may be equally angularly spaced.

The embodiment FIG. 6, and its variant above, may make use of temperature information in calculating strain, but need not necessarily do so.

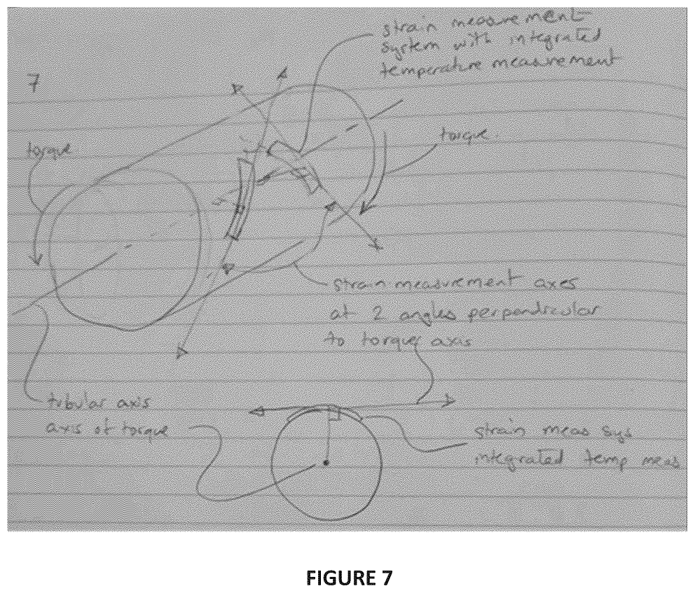

Reference is now made to FIG. 7 in which the use of two strain monitors allows for torque experienced by a submerged structure to be deduced. As shown in FIG. 7, each of the strain measuring element(s) is arranged at ninety degrees to the tubular axis of the structure. Additionally, the extent of strain monitors are each at 450 to a torsion axis, and more specifically when considering the length direction/extent of the strain measuring elements of each.

The strain at 45° to the torsion axis is given by the relationship: Mt(d/4)/(JG), where Mt is the torque, d is the distance from the torsional axis to the measurement point, J is the polar moment of inertia of the section under torsion, and G is the torsional modulus of elasticity. By measuring at two perpendicular positions inclined at substantially 45° to the longitudinal axis, the torsional strains can advantageously be decoupled from axial and bending strains on the same structural member.

The embodiment of FIG. 7 can be used with temperature measurement, or without.

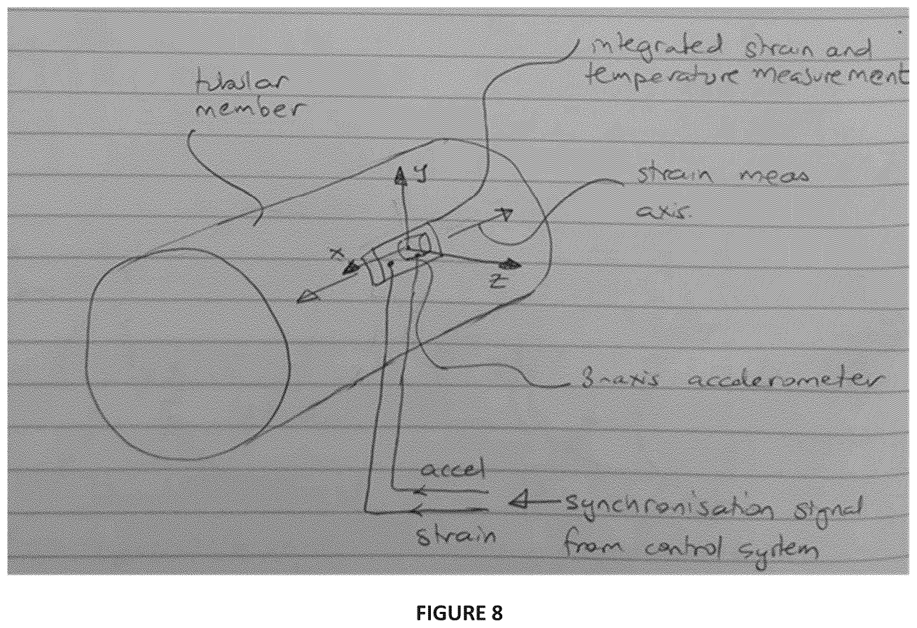

FIG. 8 shows an embodiment in which a strain monitor, which may be of the type of FIG. 1, is provided with an accelerometer on the carrier thereof. By combining synchronous measurements from acceleration sensors in one or more axes dynamic contributions to the measured stress may be correlated with the forcing motions. The strains are associated with dynamic forces that impart motion on the structure, synchronous measurement of the motion helps to interpret the structural strain response to forcing motions. Synchronisation of the accelerometer readings and the strain readings would occur within the measurement system, which would sample accelerometer and strain signals with a known and fixed timing relationship. These are important advantages to correlating accelerometer readings to strain measurements. Strain measurements determine the time-dependent magnitude of deformations in the material of the structure, while accelerations are used to measure or derive the motion, including speed or displacement, of the material. The inter-relationship of these two sets of information allows identification of the influence of externally applied forces, for example waves and currents, on both the motion and the induced stresses in a structure.

1. A strain monitor which comprises a strain gauge assembly which comprises:
a carrier, which is arranged to engage with a surface of the submerged structure, and the carrier comprises multiple engagement formations which engage with said surface;
a strain gauge, the strain gauge incorporated with the carrier; and
a temperature sensor, which is incorporated with the carrier, and arranged to sense a temperature of said surface.

2. The strain monitor of claim 1, wherein the measurement of strain and temperature is at a common measurement locality.

3. The strain monitor of claim 1, further comprising multiple engagement/contact formations which are arranged to bear against the submerged structure.

4. The strain monitor of claim 3, wherein the engagement formations are pointed, whereby a distal end is smaller than an opposite distal end.

5. The strain monitor of claim 3, wherein the temperature probe is incorporated with, into or on one or more of the engagement formations.

6. A system w comprising the strain monitor of claim 1, and a data processor, wherein the data processor is configured to determine a measure of stress-induced strain, by use of a strain measurement and a temperature measurement which are taken at a common measurement locality of the surface by the strain monitor.

7. The system of claim 6, wherein the data processor is arranged to determine the stress-induced strain by use of the relationship, or an equivalent thereto:
$$Δ L / L = αΔT + σ / E$$
where: ΔL/L is the proportionate change in length of the material under test, ΔT is the change in temperature, σ is stress, E is Youngs Modulus, and σ/E is stress-induced strain (ε).

8. A method of determining a fluid pressure to which a submerged fluid containing structure is subjected, the method comprising:
obtaining strain measurements from a strain monitor which is secured to an outer surface of a wall of the structure; and
determining a pressure value to which the structure is subjected by use of a thickness of the wall of the structure and by use of the wall's Youngs Modulus, the strain measurement along with the wall thickness and the Young's Modulus to determine said pressure value.

9. The method of claim 8, further comprising a determination of hoop stress.

10. A system which comprises a strain monitor and a data processor, and the data processor configured to process signals output by the monitor, and to use any required known values, such as thickness of the structure's wall and its Youngs Modulus and a diameter of the structure, in order to use said values and so realise the method of claim 8 to determine a measure of pressure of fluid to which the structure is subjected.

11. A strain measuring apparatus which comprises multiple strain monitors which are installed around a submerged structure, and the apparatus comprising a data processor configured to use measured strain data to determine a bending moment.

12. The apparatus of claim 11, wherein the strain monitors are installed on a (substantially singular) transverse plane of the structure.

13. The apparatus of claim 11, wherein the strain monitors are angularly distributed around the structure.

14. The apparatus of claim 11, wherein the strain monitors are positioned such that at least some of them are oppositely positioned.

15. A strain measuring apparatus which comprises two strain monitors, secured to an outer surface of submerged structure, and the strain monitors arranged at substantially 45 degrees relative to a torsional axis, and a data processor arranged to receive the strain data and thereby determine torsion to which the structure is subjected.

16. The strain monitor of claim 1, which is provided with one or more accelerometers which measure movement of the submerged structure that is monitored by the strain monitor when in use measuring strain of the structure.
